(19) United States
(12) Patent Application Publication
(10) Pub. No.: US 2014/0318270 A1
(43) Pub. Date: Oct. 30, 2014

(54) DETECTION DEVICE, ELECTRONIC APPARATUS, AND ROBOT

(71) Applicant: SEIKO EPSON CORPORATION, Tokyo (JP)

(72) Inventor: Ryoichi YONEYAMA, Hokuto-shi (JP)

(21) Appl. No.: 14/319,506

(22) Filed: Jun. 30, 2014

Related U.S. Application Data
(63) Continuation of application No. 13/325,588, filed on Dec. 14, 2011.

(30) Foreign Application Priority Data
Feb. 3, 2011 (JP) 2011-021445

(51) Int. Cl. G01L 1/04

(52) U.S. Cl. CPC G01L 1/04; Y10S 901/46
USPC 73/862.041; 901/46

(57) ABSTRACT

A detection device includes a first substrate having a plurality of force sensors disposed around respective reference points, and a second substrate on which is formed elastic protrusions whose centers of gravity are positioned in positions that overlap with respective reference points and that elastically deform due to the force in a state in which the tips of the elastic protrusions make contact with the first substrate. The second substrate is an elastic material having a predetermined elasticity.

This is a Continuation of application Ser. No. 13/325,588 filed Dec. 14, 2011, which claims the benefit of Japanese Patent Application No. 2011-021445 filed Feb. 3, 2011. The disclosures of the prior applications are hereby incorporated by reference herein in their entirety.

### BACKGROUND

1. Technical Field

The present invention relates to detection devices, electronic apparatuses, and robots.

2. Related Art

The detection devices disclosed in JP-A-60-135834 and JP-A-7-128163 are known as detection devices that detect an external force. The application of such detection devices in tactile sensors for touch panels, robots, and so on is under consideration.

The detection device disclosed in JP-A-60-135834 is configured using a force receiving sheet on the rear surface of which cone-shaped protrusions are disposed in an essentially uniform manner, and force distributions are detected from the amounts by which the protrusions deform. However, the detection device disclosed in JP-A-60-135834 cannot measure forces acting in directions along the plane for force applied to the measurement surface (that is, cannot measure sliding forces).

Meanwhile, the detection device disclosed in JP-A-7-128163 is configured with a plurality of column-shaped protrusions disposed in a matrix on the front surface of a force receiving sheet, with conical protrusions provided in the rear surface in areas that equally divide the peripheral areas of the front surface protrusions. Although the detection device disclosed in JP-A-7-128163 is capable of detecting forces as three-dimensional force vectors, the degree to which the protrusions deform, and particularly the timewise deformation retainment (that is, that once deformed, the protrusion does not return to its original state for a certain amount of time), affects the detected force of the force.

As described above, neither the detection device according to JP-A-60-135834 nor the detection device according to JP-A-7-128163 are capable of consistently detecting the direction and magnitude of a force with high sensitivity and favorable reproducibility.

### SUMMARY

It is an advantage of some aspects of the invention to provide a detection device, an electronic apparatus, and a robot capable of detecting the direction and magnitude of a force with high sensitivity and precision (an extremely low hysteresis).

Having been conceived in order to solve at least one of the aforementioned problems, the invention can be implemented as the following aspects or application examples.

### Application Example 1

A detection device according to this aspect detects the direction and magnitude of a force, and includes a first substrate that includes a plurality of force sensors disposed around a reference point, and a second substrate, having elasticity, on which is formed an elastic protrusion whose center of gravity (hereinafter called “center”) is positioned in a position that overlaps with the reference point and that elastically deforms due to the force in a state in which the tip of the elastic protrusion makes contact with the first substrate; the second substrate is an elastic material having a predetermined elasticity.

Note that the stated “center” refers to the center of the force.

### Application Example 2

It is preferable that the detection device according to the aforementioned aspect further include an elastic sheet provided between the elastic protrusion and the first substrate, and the tip of the elastic protrusion make contact with the elastic sheet.

### Application Example 3

It is preferable that a detection device according to this aspect detect the direction and magnitude of a force, and include a first substrate that has a plurality of force sensors disposed around a reference point, an elastic protrusion whose center is positioned in a position that overlaps with the reference point and that elastically deforms due to the force, and a second substrate provided so as to oppose the first substrate with the elastic protrusion therebetween; the elastic protrusion be formed on the first substrate so that the tip of the elastic protrusion makes contact with the second substrate; and the second substrate be an elastic material having a predetermined elasticity.

### Application Example 4

The detection device according to the aforementioned aspect may further include a support portion that anchors an outer peripheral area of the second substrate in a state in which the support portion applies a tension to the second substrate.

According to this configuration, the tip of the elastic protrusion can deform in the sliding direction (a direction parallel to the surface of the force sensors) while making contact with the first substrate (the plurality of force sensors), and thus the precision with which the direction and magnitude of the force is detected can be increased compared to the detection devices disclosed in JP-A-60-135834 and JP-A-7-128163. When a force is applied to the surface of the second substrate, the elastic protrusion is compressed and deforms with its tip making contact with the first substrate. Here, in the case where there is a sliding force component in a predetermined direction along the surface, the elastic protrusion deforms in an unbalanced manner. In other words, the center of the elastic protrusion shifts from the reference point and moves in a predetermined direction (the sliding direction). Upon doing so, the ratio of force sensors that overlap with areas in which the center of the elastic protrusion has moved becomes relatively greater. In other words, different force values are detected by the respective force sensors. Specifically, a relatively large force value is detected by force sensors in positions that overlap with the center of the elastic protrusion, whereas a relatively small force value is detected by force sensors in positions that do not overlap with the center of the elastic protrusion. Accordingly, the calculation device can calculate the difference between the force values detected by the respective force sensors and find the direction and magnitude of the force based on that difference. It is therefore possible to provide a detection device that is capable of detecting the direction and magnitude of a force with high precision.

### Application Example 5

It is preferable that the detection device according to the aforementioned aspect further include a calculation device that calculates differences between force values detected by force sensors combined at random from among force values detected by the plurality of force sensors as the elastic protrusion elastically deforms due to the force, and calculate the direction in which the force is applied and the magnitude of the force based on the differences.

### Application Example 6

In the detection device according to the aforementioned aspect, it is preferable that the plurality of force sensors be disposed symmetrically, with the reference point serving as the point of symmetry.

According to this detection device, the distances between the reference point and each of the force sensors are the same, and thus the relationships between the amount of deformation of the elastic protrusion and the force values detected by the respective force sensors are the same. For example, in the case where the plurality of force sensors are disposed at different distances from a reference point, the force values detected by the respective force sensors will differ from each other even if the amount of deformation of the elastic protrusion is the same. Accordingly, when computing the difference between detected values, a correction coefficient based on the disposal locations of the force sensors is necessary. However, according to this configuration, the relationships between the amount of deformation of the elastic protrusion and the force values detected by the respective force sensors are the same, and thus the stated correction coefficient is unnecessary. Accordingly, it is easier to calculate the direction and magnitude of the force from the force values detected by the force sensors, which makes it possible to detect the force in an efficient manner.

### Application Example 7

In the detection device according to the aforementioned aspect, it is preferable that the plurality of force sensors be disposed in matrix form in two directions that are orthogonal to each other.

According to this detection device, it is easy to compute the direction and magnitude of the force based on the differences between the force values of force sensors combined at random, from among the force values of the force sensors.

### Application Example 8

In the detection device according to the aforementioned aspect, it is preferable that the plurality of force sensors be disposed in two directions that are orthogonal to each other, with at least four columns and four rows.

### Application Example 9

In the detection device according to the aforementioned aspect, it is preferable that the elastic protrusion be formed in plurality on the second substrate, and the plurality of elastic protrusions be disposed so as to be distanced from each other.

According to this detection device, a greater number of force sensors are disposed. For this reason, the direction and magnitude of the force can be found by calculating the detection results for the force sensors based on the force values detected by the large number of force sensors. Accordingly, it is possible to detect the direction and magnitude of the force with high precision.

According to this detection device, when a single elastic protrusion experiences elastic deformation within the plane of the second substrate, adjacent elastic protrusions that do not experience elastic deformation or experience a low amount of elastic deformation attempt to return the elastic deformation of the stated single elastic protrusion to its initial state. For example, when a single elastic protrusion has deformed and the force is then released, the elastic protrusions in the periphery thereof affect to the elastic material in which this deformation has occurred, and pull on each other in such a manner as to quickly restore the amount of deformation to its initial state. For this reason, it is possible for an elastic protrusion that has experienced elastic deformation to quickly return to an initial state in which the force is not applied. Accordingly, it is possible to consistently detect the direction and magnitude of a force with high sensitivity and high reproducibility (that is, with extremely low hysteresis). Furthermore, by adjusting the strength of this pulling through the material or the inherent tension thereof, the range of the detection strength of the apparatus can be controlled so as to take on a predetermined range.

### Application Example 10

It is preferable that an electronic apparatus according to this aspect include the detection device according to the aforementioned aspect.

According to this electronic apparatus, the detection device according to the aforementioned aspect is provided, and it is thus possible to provide an electronic apparatus capable of consistently detecting the direction and magnitude of a force with high sensitivity and high precision (that is, with extremely low hysteresis).

### Application Example 11

It is preferable that a robot according to this aspect includes the detection device according to the aforementioned aspect.

According to this robot, the aforementioned detection device is provided, and it is thus possible to provide a robot capable of consistently detecting the direction and magnitude of a force with high sensitivity and high precision (that is, with extremely low hysteresis).

### BRIEF DESCRIPTION OF THE DRAWINGS

The invention will be described with reference to the accompanying drawings, wherein like numbers reference like elements.

FIG. 1 is an exploded perspective view illustrating the overall configuration of a detection device according to a first embodiment.

FIGS. 2A through 2C are cross-sectional views illustrating a change in force values taken by force sensors according to the first embodiment.

FIGS. 3A through 3C are plan views illustrating a change in force values taken by force sensors according to the first embodiment.

FIG. 4 is a diagram illustrating a coordinate system in a sensing region according to the first embodiment.

FIG. 5 is a diagram illustrating a force distribution in the vertical direction taken by force sensors according to the first embodiment.

FIG. 6 is a diagram illustrating an example of calculating a sliding direction by force sensors according to the first embodiment.

FIGS. 7A through 7E are cross-sectional views illustrating a relationship between elastic protrusions and a second main substrate portion with force sensors according to the first embodiment.

FIGS. 8A through 8C are diagrams expressing relationships of effects of force sensors according to the first embodiment.

FIGS. 9A through 9E are cross-sectional views illustrating a relationship between elastic protrusions and a second main substrate portion with force sensors according to a second embodiment.

FIG. 10 is a cross-sectional view illustrating a relationship between elastic protrusions and a second main substrate portion with force sensors according to a third embodiment.

FIGS. 11A through 11C are cross-sectional views illustrating a method for connecting elastic protrusions of a force sensor to a second main substrate portion according to the third embodiment.

FIG. 12 is a schematic diagram illustrating the overall configuration of a mobile telephone serving as an example of an electronic apparatus.

FIG. 13 is a schematic diagram illustrating the overall configuration of a personal digital assistant serving as an example of an electronic apparatus.

FIGS. 14A and 14B are schematic diagrams illustrating the overall configuration of a robot hand serving as an example of a robot.

### DESCRIPTION OF EXEMPLARY EMBODIMENTS

Hereinafter, embodiments of the invention will be described with reference to the drawings. The embodiments illustrate only several aspects of the invention, and are not intended to limit the invention in any way; many variations can be made on the invention without departing from the scope of the technical spirit of the invention. Furthermore, to facilitate understanding of the various configurations, the scale, numbers, and so on of the various structures depicted in the drawings differ from those of the actual structures.

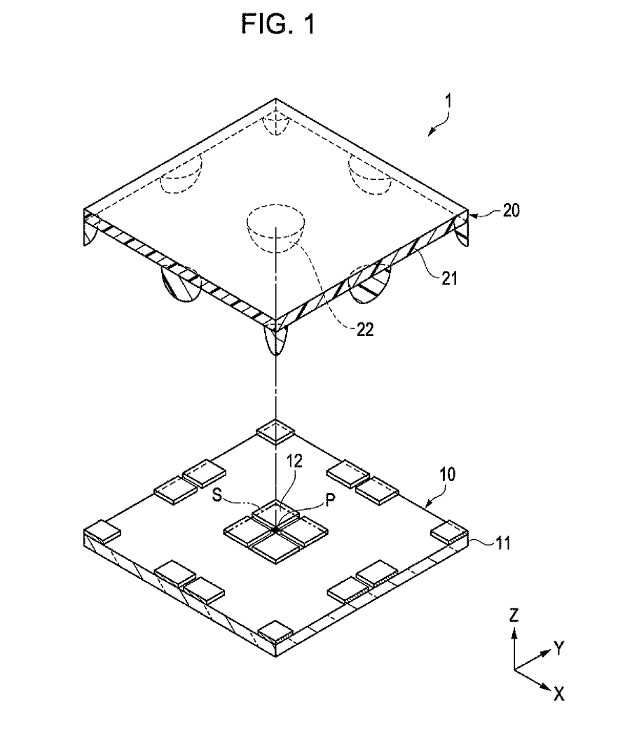

In the following descriptions, it is assumed that the XYZ orthogonal coordinate system indicated in FIG. 1 is employed, and the various members will be described with reference to this XYZ orthogonal coordinate system. In the XYZ orthogonal coordinate system, the X axis and Y axis are set to the directions that are parallel to the sides of a first substrate 10, whereas the Z axis is set to the direction that is orthogonal to the X axis and the Y axis.

### First Embodiment

FIG. 1 is an exploded perspective view illustrating the overall configuration of a detection device according to a first embodiment of the invention. In FIG. 1, reference symbol P indicates a reference point, whereas reference symbol S indicates a unit detection region on which a plurality of force sensors 12 disposed in correspondence to a single elastic protrusion 22 carry out detection.

The detection device according to this embodiment is a force sensor-type touchpad that detects the direction and magnitude of a force applied to the reference point, and is used as, for example, a pointing device for an electronic apparatus such as a laptop computer or the like, in place of a mouse. Note that “reference point” refers to a point within the plane in which the center of the elastic protrusion is located in the case where a sliding force is not acting.

As shown in FIG. 1, a detection device 1 includes the first substrate 10 that has the plurality of force sensors 12 disposed around the reference point P, and a second substrate 20 in which the elastic protrusion 22, which is disposed with its center in a position that overlaps with the position of the reference point P and which experiences elastic deformation when its tip makes contact with the first substrate 10 due to a force, is formed.

The detection device 1 includes a calculation device (not shown) that calculates the difference between force values detected by force sensors 12 combined at random from among the force values detected by the plurality of force sensors 12 when the elastic protrusion 22 experiences elastic deformation due to a force, and calculates the direction and magnitude of the force based on that difference.

The first substrate 10 is configured so as to include a rectangular plate-shaped first main substrate portion 11 configured of a material such as glass, silica, or plastic and the plurality of force sensors 12 disposed on the first main substrate portion 11. The size of the first main substrate portion 11 (when viewed from above) is, for example, approximately 56 mm on the vertical and 56 mm on the horizontal.

The plurality of force sensors 12 are disposed symmetrically using the reference point P as the point of symmetry. For example, the plurality of force sensors 12 are disposed in matrix form in two directions that are orthogonal to each other (the X direction and the Y direction). Accordingly, the distances between the reference point P and each of the force sensors 12 are the same, and thus the relationships between the deformation of the elastic protrusion and the force values detected by the respective force sensors 12 are the same. It is thus easy to calculate the difference between the force values detected by random combinations of the force sensors 12 from among the force values of the force sensors 12. Note that a method for calculating the difference between force values will be described later.

The gap between adjacent force sensors 12 is approximately 0.1 mm. Accordingly, noise caused by the effects of disturbances, static electricity, and so on does not enter into the force values detected by force sensors 12 that are in adjacent positions.

A total of four force sensors 12, or two rows on the vertical and two columns on the horizontal, are disposed per unit detection region S. The center of the four force sensors 12 (that is, the center of the unit detection region S) corresponds to the reference point P. The size of the unit detection region S (when viewed from above) is, for example, approximately 2.8 mm on the vertical and 2.8 mm on the horizontal. Furthermore, the surface area of each of the four force sensors 12 is approximately the same. A force-sensitive element such as a diaphragm gauge can be used as the force sensor 12. The force sensors 12 convert force applied to the diaphragm when a force is acting on a contact surface into an electric signal.

The second substrate 20 is configured so as to include a rectangular plate-shaped second main substrate portion 21 and the plurality of elastic protrusions 22 disposed on the second main substrate portion 21. The second main substrate portion 21 is a portion that directly receives forces. The second main substrate portion 21 is configured using, for example, an elastic material such as silicone rubber. In this embodiment, the second main substrate portion 21 and the elastic protrusions 22 are attached to each other using an adhesive, but the second main substrate portion 21 and the elastic protrusions 22 may be formed as an integrated entity using a mold.

The plurality of elastic protrusions 22 are disposed in matrix form along the X direction and the Y direction on the second main substrate portion 21. The tips of the elastic protrusions 22 are cone-shaped spherical surfaces, and make contact with the first substrate 10 (and more specifically, with the plurality of force sensors 12 disposed upon the first main substrate portion 11). The elastic protrusions 22 are disposed in positions where the centers thereof initially overlap with the reference point P. Furthermore, the plurality of elastic protrusions 22 are disposed so as to be distanced from each other. Accordingly, when the elastic protrusions 22 experience elastic deformation, a certain amount of deformation in the direction parallel to the surface of the second main substrate portion 21 can be permitted.

The size of the elastic protrusions 22 can be set as desired. Here, the diameter of the base portion of the elastic protrusions 22 (that is, the diameter of the area where the elastic protrusions 22 make contact with the first substrate 10) is approximately 1.8 mm. The height of the elastic protrusions 22 (that is, the distance of the elastic protrusions 22 in the Z direction) is approximately 2 mm. The gap between adjacent elastic protrusions 22 is approximately 1 mm. Finally, the durometer rating of the elastic protrusions 22 (that is, a stiffness value measured by a type A, ISO 7619-compliant durometer) is approximately 30.

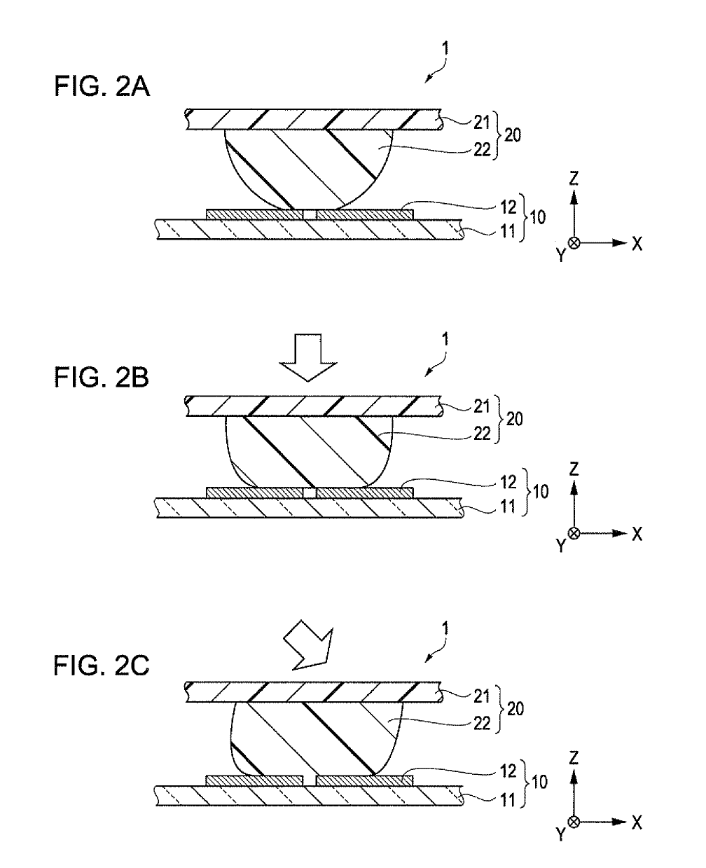

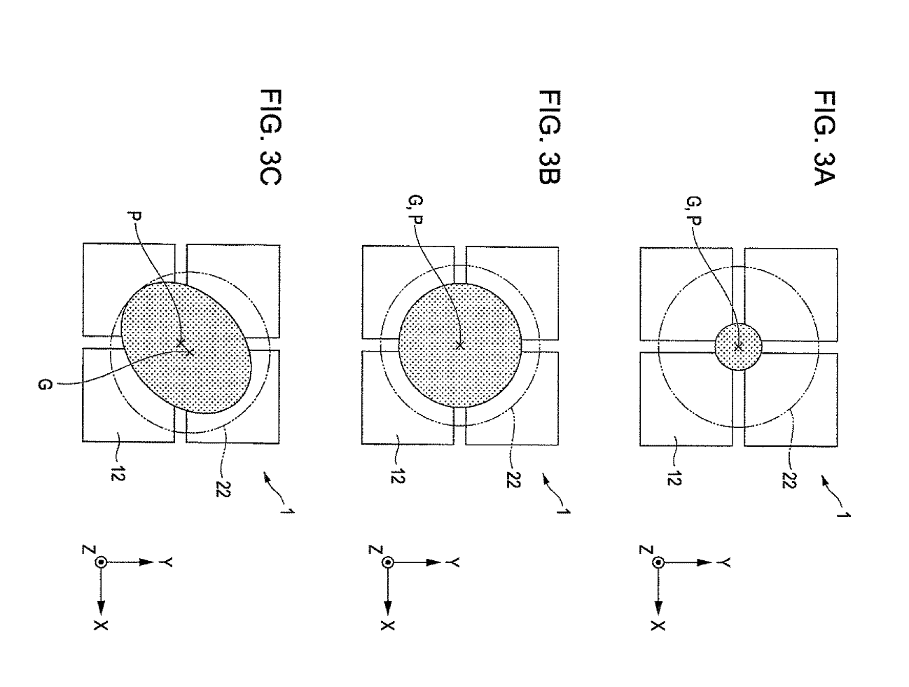

FIGS. 2A through 2C and FIGS. 3A through 3C are descriptive diagrams illustrating a method for detecting the direction and magnitude of a force acting on the reference point P. FIGS. 2A through 2C are cross-sectional views illustrating a change in force values taken by the force sensors according to the first embodiment. FIGS. 3A through 3C are plan views, corresponding to FIGS. 2A through 2C, illustrating a change in the force values taken by the force sensors according to the first embodiment. Note that FIG. 2A and FIG. 3A illustrate a state prior to a force being applied to the surface of the second substrate 20 (that is, a state where there is no external force acting). FIG. 2B and FIG. 3B, meanwhile, illustrate a state in which a force in the vertical direction (in a state in which there is no sliding force) is applied to the surface of the second substrate 20. FIG. 2C and FIG. 3C illustrate a state in which a force in a diagonal direction (in a state in which there is a sliding force) is applied to the surface of the second substrate 20. Meanwhile, in FIGS. 3A to 3C, the reference symbol G indicates the center (force center) of the elastic protrusion 22.

As shown in FIG. 2A and FIG. 3A, the elastic protrusion 22 does not deform before a force is applied to the surface of the second substrate 20. Accordingly, the distance between the first substrate 10 and the second substrate 20 is kept constant. At this time, the elastic protrusion 22 is disposed in a position where the center G thereof overlaps with the reference point P. The force values of the respective force sensors 12 at this time are stored in a memory (not shown). The direction, magnitude, and so on of an acting force is found using the force values of the force sensors 12 stored in the memory as a reference.

As shown in FIG. 2B and FIG. 3B, when a force in the vertical direction is applied to the surface of the second substrate 20, the elastic protrusion 22 is compressed and deforms in the Z direction in a state in which the tip of the elastic protrusion 22 makes contact with the plurality of force sensors 12 disposed on the surface of the first substrate 10. Accordingly, the second substrate 20 bends in the −Z direction, and the distance between the first substrate 10 and the second substrate 20 decreases compared to when the force is not acting. The force values of the force sensors at this time are greater compared to when the force is not acting. Furthermore, the amount of change thereof is approximately the same value for each of the force sensors.

As shown in FIG. 2C and FIG. 3C, when a force in a diagonal direction is applied to the surface of the second substrate 20, the elastic protrusion 22 is compressed and deforms in a tilted manner, in a state in which the tip of the elastic protrusion 22 makes contact with the plurality of force sensors 12 disposed on the surface of the first substrate 10. Accordingly, the second substrate 20 bends in the −Z direction, and the distance between the first substrate 10 and the second substrate 20 decreases compared to when the force is not acting. At this time, the center G of the elastic protrusion 22 shifts in the +X direction and the +Y direction from the reference point P. In this case, the tip of the elastic protrusion 22 overlaps with different amounts of surface area in each of the four force sensors 12. To be more specific, the tip of the elastic protrusion 22 overlaps with a greater surface area of the force sensors 12 disposed in the +X direction and the +Y direction than of the force sensors 12 disposed in the −X direction and the −Y direction.

The elastic protrusion 22 deforms in an unbalanced manner due to a force in a diagonal direction. In other words, the center of the elastic protrusion 22 shifts from the reference point P and moves in a sliding direction (the X direction and the Y direction). As a result, different force values are detected by the respective force sensors. Specifically, a relatively large force value is detected by force sensors in positions that overlap with the center of the elastic protrusion 22, whereas a relatively small force value is detected by force sensors in positions that do not overlap with the center of the elastic protrusion 22. The direction and magnitude at which the force was applied is found based on a difference calculation method that will be described later.

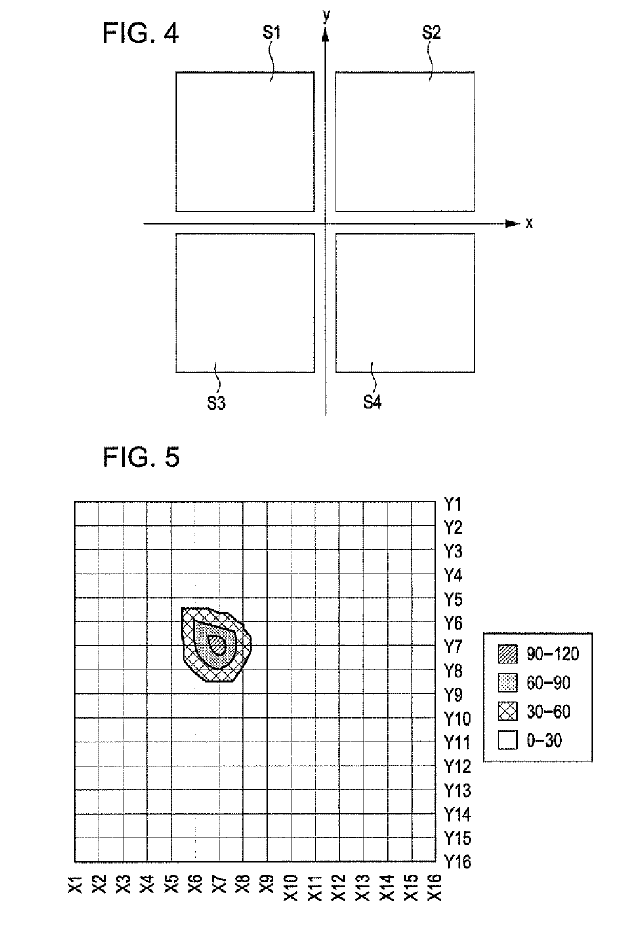

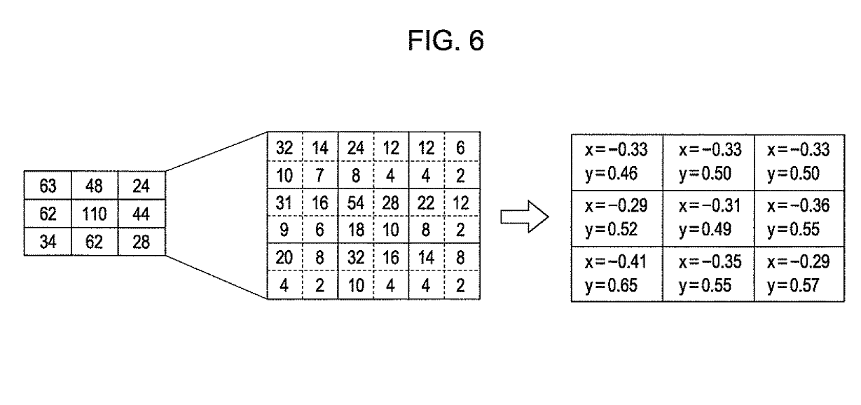

FIG. 4 is a diagram illustrating a coordinate system in a sensing region according to the first embodiment. FIG. 5, meanwhile, is a diagram illustrating a force distribution in the vertical direction taken by the force sensors according to the first embodiment. FIG. 6 is a diagram illustrating an example of calculating a sliding direction by the force sensors according to the first embodiment.

As shown in FIG. 4, a total of four force sensors S1 through S4 are disposed per unit detection region S, with two rows on the vertical and two columns on the horizontal. Here, assuming that the force values detected by the force sensors S1 through S4 (that is, detected values) are PS₁, PS₂, PS₃, and PS₄, respectively, an X direction component Fx of the external force (that is, the ratio of the directional component of the external force within the plane that acts in the X direction) is expressed by the following Formula (1).

$${F}_{x} = \frac{( {P}_{S 2} + {P}_{S 4} ) - ( {P}_{S 1} + {P}_{S 3} )}{{P}_{S 1} + {P}_{S 2} + {P}_{S 3 } + {P}_{S 4}} \qquad Formula ( 1 )$$

Furthermore, a Y direction component Fy of the external force (that is, the ratio of the directional component of the external force within the plane that acts in the Y direction) is expressed by the following Formula (2).

$${F}_{y} = \frac{( {P}_{S 1} + {P}_{S 2} ) - ( {P}_{S 3} + {P}_{S 4} )}{{P}_{S 1} + {P}_{S 2} + {P}_{S 3 } + {P}_{S 4}} \qquad Formula ( 2 )$$

Finally, a Z direction component Fz of the external force (that is, the vertical direction component of the external force) is expressed by the following Formula (3).

F_{z}=P_{S1}+P_{S2}+P_{S3}+P_{S4} Formula (3)

In this embodiment, the difference between the force values detected by force sensors combined at random from among the force values detected by the four force sensors S1 through S4 when the elastic protrusion experiences elastic deformation due to the force is calculated, and the direction of the force is calculated based on that difference.

As shown in Formula (1), for the X direction component Fx of the force, of the force values detected by the four force sensors S1 through S4, the values detected by the force sensors S2 and S4 disposed in the +X direction are combined, and the values detected by the force sensors S1 and S3 disposed in the −X direction are combined. In this manner, the X direction component of the force is found based on the difference between the force values in the combination of the force sensors S2 and S4 disposed in the +X direction and the force values in the combination of the force sensors S1 and S3 disposed in the −X direction.

As shown in Formula (2), for the Y direction component Fy of the force, of the force values detected by the four force sensors S1 through S4, the values detected by the force sensors S1 and S2 disposed in the +Y direction are combined, and the values detected by the force sensors S3 and S4 disposed in the −Y direction are combined. In this manner, the Y direction component of the force is found based on the difference between the force values in the combination of the force sensors S1 and S2 disposed in the +Y direction and the force values in the combination of the force sensors S3 and S4 disposed in the −Y direction.

As shown in Formula (3), for the Z direction component Fz of the force, the resultant force is found by adding together the force values of the four force sensors S1 through S4. However, a greater detected value tends to be detected for the Z direction component Fz of the force than for the X direction component Fx of the force and the Y direction component Fy of the force (component forces). For example, the detection sensitivity for the Z direction component Fz of the force will increase if a stiff material is used for the elastic protrusion 22, the tip of the elastic protrusion 22 has a sharp shape, and so on. However, using a stiff material for the elastic protrusion 22 makes it difficult for the elastic protrusion 22 to deform and thus reduces the detected value in the force within the plane. In addition, if the tip of the elastic protrusion 22 has a sharp shape, there are cases where (abnormally) strong tactile feedback will occur when the contact surface is touched with a finger. Accordingly, it is necessary to correct the detected values as appropriate using a correction coefficient determined based on the material, shape, and so on of the elastic protrusion 22 in order to align the detected value of the Z direction component Fz of the force with the detected values of the X direction component Fx and the Y direction component Fy of the force.

A case will now be considered in which a location to the upper-left of the center portion of the detection surface of a touchpad is pushed diagonally with a finger, as shown in FIG. 5. At this time, the force in the vertical direction is greatest in the center portion of the area on which the force acts (the output voltage of the force sensor is approximately 90 to 120 mV). The force in the vertical direction is lower in the peripheral region following the center portion (approximately 60 to 90 mV), and is lower still in the outermost area (approximately 30 to 60 mV). Meanwhile, the region not pushed by the finger has a force sensor output voltage of approximately 0 to 30 mV. Note that it is assumed here that a plurality of unit detection regions (the region in which a total of four force sensors S1 through S4 are disposed, with two rows on the vertical and two columns on the horizontal) are disposed in matrix form in the touchpad (with, for example, a total of 225 regions, with 15 rows on the vertical and 15 columns on the horizontal).

A method for calculating the directional components of the force within the surface (that is, the sliding direction) in the case where a location to the upper-left of the center portion of the detection surface of a touchpad is pushed diagonally with a finger, as shown in FIG. 6, will now be considered. It is assumed here that the compressive force of the finger (the external force) is acting on an area that is three rows on the vertical and three columns on the horizontal, from among the 15 rows on the vertical and 15 columns on the horizontal. Here, the force in the vertical direction is, as in FIG. 5, greatest at the center portion of the area in which the force is acting (110 mV).

The unit detection regions disposed at three rows on the vertical and three columns on the horizontal each have the four force sensors S1 through S4; the difference between the force values detected by force sensors combined at random from among the force values detected by the force sensors S1 through S4 is calculated, and the direction of the force is calculated based on that difference. In other words, in each unit detection region, the X direction component Fx of the force and the Y direction component Fy of the force are calculated based on the aforementioned Formula (1) and Formula (2). Here, it can be seen that, if the +X direction is taken as a reference, the force is acting in the direction that is approximately 123° in the counterclockwise direction. Note that the direction in which the force is acting can be calculated by using a method that finds the direction using the average value of the nine calculation results or a method that finds the direction from the maximum value (for example, a detected value that is greater than a predetermined threshold) in the nine calculation results.

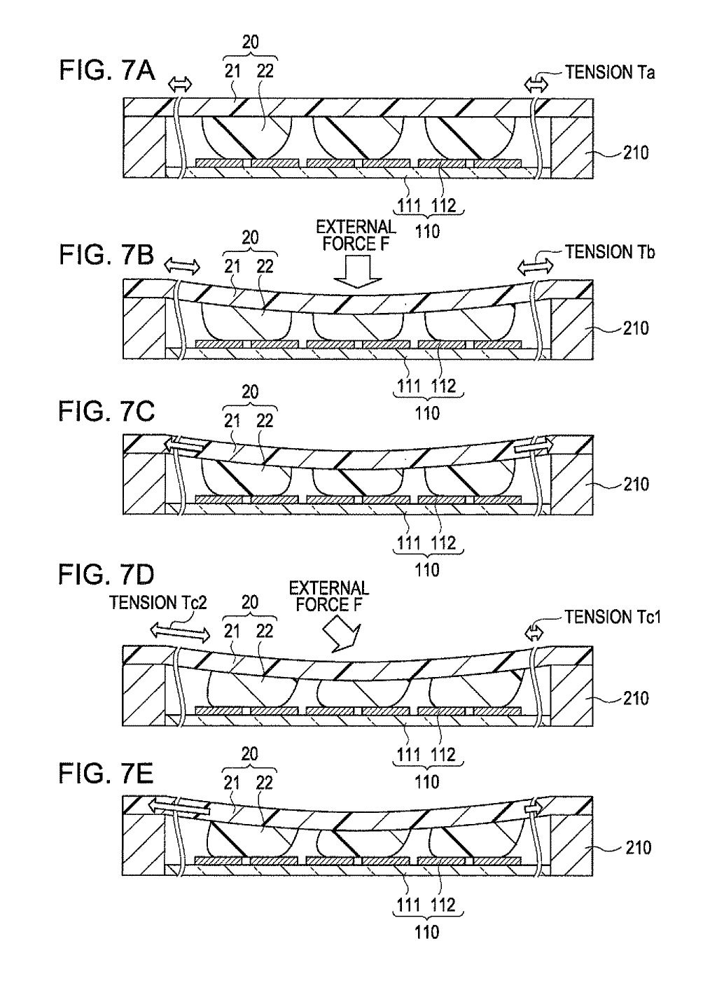

FIGS. 7A through 7E are diagrams illustrating a relationship between the plurality of elastic protrusions 22 and the second main substrate portion 21 in the case where a force has been applied/released, according to the first embodiment.

As shown in FIG. 7A, the second substrate 20 is configured using an elastic material such as silicone rubber. The elastic protrusions 22 and the second main substrate portion 21 are attached to each other, and adjacent elastic protrusions 22 pull on each other, and thus affect each other, through the second main substrate portion 21.

The outermost sides of the second substrate 20 are anchored to a frame 210, in a tensioned state. Note that the second substrate 20 does not necessarily have to be anchored to the frame 210, as long as there is tension when external force is applied thereto. For example, although not shown in the drawings, in the case where the detection device 1 according to this embodiment is wound upon a cylindrical object, the second substrate 20 takes on a ring shape, and such a configuration may be employed as long as tension arises when the second substrate 20 is attached to the cylindrical object.

Meanwhile, in the case where the elastic protrusions 22 and the second main substrate portion 21 are formed as an integral entity using an elastic material such as silicone rubber, the configuration may be such that, when using a flat installation, the outer sides are not anchored, as long as a tension arises at least when force is applied thereto.

FIG. 7B is a diagram illustrating a relationship between the plurality of elastic protrusions 22 and the second main substrate portion 21 in the case where a force F has been applied vertically to the second substrate 20.

Due to the force F, the elastic protrusions 22 and the second main substrate portion 21 deform in an almost uniform manner essentially concentrically central to the point where the force F is applied, and a tension Tb arises resultantly in the second main substrate portion 21 to an essentially uniform extent on the outer sides of the second main substrate portion 21.

FIG. 7C is a diagram illustrating a relationship between the plurality of elastic protrusions 22 and the second main substrate portion 21 in the case where the stated external force F has been released.

The tension Tb, which was acting essentially uniformly on the outer sides of the second main substrate portion 21, returns the second substrate, which is deformed, to its original state in which the external force is not applied (that is, the state of the second substrate in FIG. 7A).

FIG. 7D is a diagram illustrating a relationship between the plurality of elastic protrusions 22 and the second main substrate portion 21 in the case where a force F has been applied at an angle to the second substrate 20.

Due to the force F, the elastic protrusions 22 and the second main substrate portion 21 deform non-uniformly in an unbalanced manner, and as a result, unbalanced tensions Tc1 and Tc2 arise in the second main substrate portion 21.

The magnitudes of the tensions Tc1 and Tc2 are defined so that Tc1<Tc2; meanwhile, Tc1 and Tc2 arise between the location where the force F is applied and the frame 210, and are combinations of the vector component force of the force F in the X-Y plane and the tension arising in the second substrate 20 when the force F is not applied.

FIG. 7E is a diagram illustrating a relationship between the plurality of elastic protrusions 22 and the second main substrate portion 21 in the case where the stated external force has been released.

The unbalanced tensions Tc1 and Tc2 in the second main substrate portion 21 return the second substrate, which is deformed, to its original state in which the external force is not applied (that is, the state of the second substrate in FIG. 7A).

According to the detection device 1 of this embodiment, the tip of the elastic protrusion 22 deforms in the sliding direction (a direction parallel to the surface of the force sensors 12) while making contact with the first substrate 10 (the plurality of force sensors 12), and thus the precision with which the direction of the force is detected can be increased compared to the detection devices disclosed in JP-A-60-135834 and JP-A-7-128163. When a force is applied to the surface of the second substrate 20 in a predetermined direction, the elastic protrusion 22 is compressed and deforms in a state in which the tip of the elastic protrusion 22 makes contact with the plurality of force sensors 12 disposed on the first substrate 10. At this time, an imbalance occurs in the deformation of the elastic protrusion 22. In other words, the center of the elastic protrusion 22 shifts from the reference point P and moves in a predetermined direction (the sliding direction). Upon doing so, the ratio of the plurality of force sensors 12 that overlap with areas in which the center of the elastic protrusion 22 has moved becomes relatively greater. In other words, different force values are detected by the respective force sensors S1 through S4. Specifically, a relatively large force value is detected by force sensors 12 in positions that overlap with the center of the elastic protrusion 22, whereas a relatively small force value is detected by force sensors 12 in positions that do not overlap with the center of the elastic protrusion 22. Accordingly, the calculation device can calculate the difference between the force values detected by the respective force sensors S1 through S4 and find the direction of the force based on that difference. It is therefore possible to provide the detection device 1, which is capable of detecting the direction of a force with high precision.

According to this configuration, the plurality of force sensors 12 are disposed symmetrically with the reference point P serving as the point of symmetry, and thus the distances between the reference point P and each of the force sensors 12 are the same. Accordingly, the force values detected by the force sensors S1 through S4 are the same as one another. For example, in the case where the plurality of force sensors are disposed at different distances from the reference point, the force values detected by the respective force sensors will differ from each other. Accordingly, when calculating the difference between detected values, a correction coefficient based on the disposal locations of the force sensors S1 through S4 is necessary. However, according to this configuration, the force values detected by the force sensors S1 through S4 are the same, and thus the aforementioned correction coefficient is unnecessary. Accordingly, it is easier to compute the differences between the force values of the force sensors S1 through S4, which makes it possible to detect the force in an efficient manner.

Furthermore, according to this configuration, the plurality of force sensors 12 are arranged in matrix form in two directions that are orthogonal to each other, and therefore it is easy to compute the differences between the force values detected by force sensors 12 combined at random, from among the force values detected by the force sensors S1 through S4. For example, when calculating the X direction component of the directional components within the plane, it is easier to separate the force sensors S2 and S4 disposed relatively in the +X direction into one combination and the force sensors S1 and S3 disposed relatively in the −X direction into another combination, and select the sensors, as compared to a case where the plurality of force sensors 12 are disposed at random in a plurality of directions. Accordingly, external forces can be detected efficiently.

According to this configuration, the plurality of elastic protrusions 22 are disposed with gaps between each other, and thus when the elastic protrusions 22 experience elastic deformation, a certain amount of deformation in the direction parallel to the surface of the second main substrate portion 21 can be permitted. For example, it is possible to suppress the influence of the deformation of one of the elastic protrusions 22 when another elastic protrusion 22 has deformed. Accordingly, a force can be transmitted to the force sensors S1 through S4 more efficiently, compared to a case in which the plurality of elastic protrusions 22 are disposed so as to make contact with each other. Accordingly, it is possible to detect the direction of the force with high precision.

Furthermore, according to this configuration, when a single elastic protrusion 22 has experienced elastic deformation within the plane of the second substrate 20, the adjacent elastic protrusions 22 that are not experiencing elastic deformation or are experiencing little elastic deformation attempt to return the elastic deformation of the stated single elastic protrusion 22 to its original state. As a result, it is possible to consistently detect the direction and magnitude of a force with a high sensitivity and a high reproducibility (that is, with extremely low hysteresis).

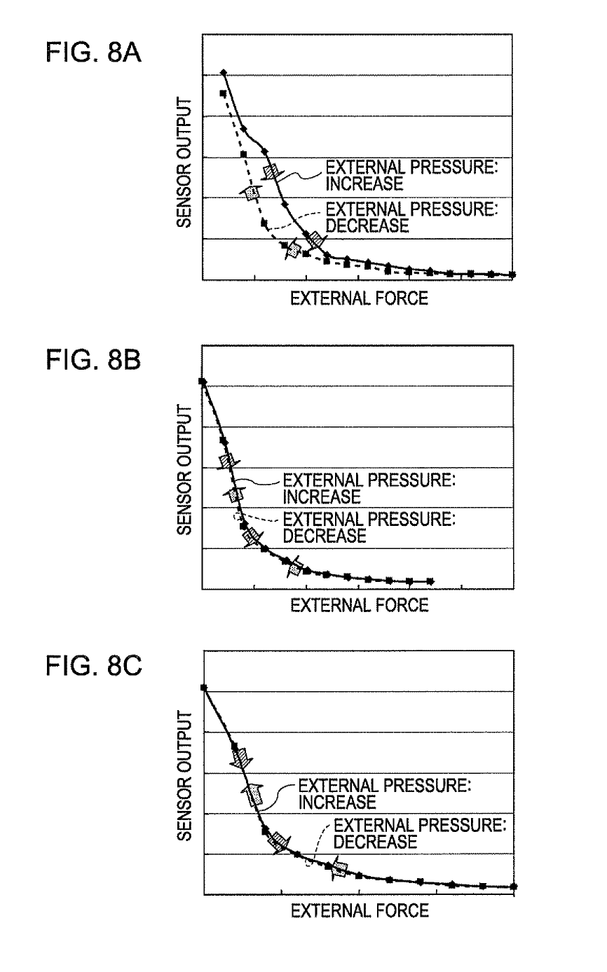

FIGS. 8A through 8C compare sensor output values between cases in which the outermost sides of the second substrate 20 are affixed to the frame 210 in this configuration and a tension is applied to the second substrate 20, and cases in which the second substrate 20 is not provided and the tensions are not applied to the elastic protrusions 22.

FIG. 8A illustrates a case in which the second substrate 20 is not provided and a tension is not applied to the second substrate 20, and illustrates the transition of output values when a force has been applied (increased) and when the force has been released (reduced) in the case where the elastic protrusions 22 do not affect each other through the tension.

From this diagram, it can be seen that the output values differ greatly between when the force has been applied (increased) and when the force has been released (reduced); hysteresis can be confirmed, and it can be seen that the sensitivity and the reproducibility decrease.

FIG. 8B illustrates the transition of output values from sensors when a force has been applied (increased) and when the force has been released (reduced) in the case where the second substrate according to this embodiment is provided and a tension is applied to the second substrate 20.

From this diagram, it can be seen that the output values are the same when the force has been applied (increased) and when the force has been released (reduced); there is thus no hysteresis, and it can be seen that there is no decrease in the sensitivity and the reproducibility can be seen.

Note that it can also be seen that due to the improvement in the sensitivity, a desired force sensor output value is obtained even when the strength of the force, indicated by the horizontal axis of the graph, is low.

FIG. 8C illustrates a higher tension applied to the second substrate 20 than in FIG. 8B, for sensors in the case where the second substrate according to this embodiment is provided.

From this diagram, it can be seen that the output values are the same when the force has been applied (increased) and when the force has been released (reduced); furthermore, the output values can be caused to fluctuate while maintaining a state in which there is no hysteresis, and it is possible to control the desired output value by changing the tension applied to the second substrate 20.

Note that an appropriate value for the tension applied to the elastic protrusions 22 of the second substrate 20 may be selected based on the material, number disposed, shape, and thickness of the second substrate 20, the sensitivity of the sensors in the first substrate 10, and so on. At the same time, the elastic material sheet used for the second main substrate portion 21 may be any shape, thickness, material, or elasticity as long as the desired tension can be obtained.

In addition, the type of the sensors in the first substrate 10 is not limited to the electrostatic capacitance type, a resistance type, or the like.

Although this embodiment describes an example in which a total of four force sensors 12 are disposed per unit detection region S, with two rows on the vertical and two columns on the horizontal, the invention is not limited thereto. Any number can be employed as long as there are no less than three force sensors 12 disposed per unit detection region S.

### Second Embodiment

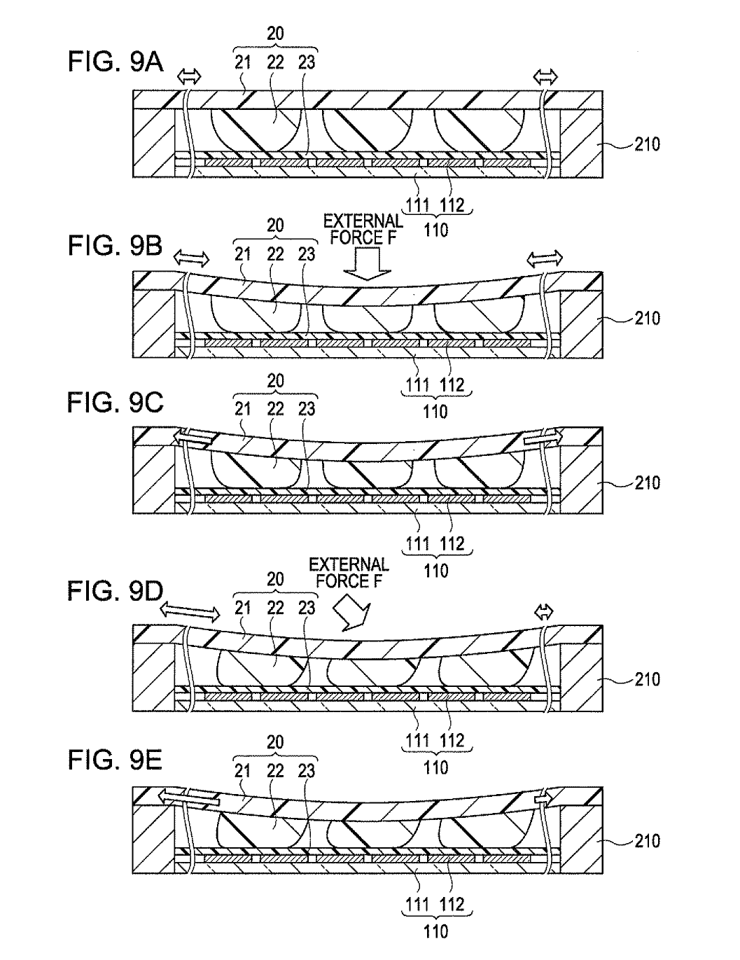

FIGS. 9A through 9E are cross-sectional views, corresponding to FIGS. 7A through 7E, illustrating changes in force values detected by force sensors in a detection device 2 according to a second embodiment of the invention, and are diagrams illustrating a relationship between the plurality of elastic protrusions 22, the second main substrate portion 21, and a second substrate reinforcing portion 23 in the case where a force has been modified. In FIGS. 9A through 9E, elements identical to those in the detection device 1 of the first embodiment (see FIGS. 7A through 7E) are given identical reference numerals, and detailed descriptions thereof will be omitted.

As shown in FIGS. 9A through 9E, the detection device 2 includes the second substrate 20. The second substrate 20 is configured of the elastic protrusions 22, the second main substrate portion 21, and the second substrate reinforcing portion 23. The second substrate 20 is configured of silicone rubber or the like having elasticity, and as a result can generate a tension. The outermost sides of the second substrate 20 are anchored to the frame 210, thus generating tension.

Note that the second substrate 20 does not necessarily have to be anchored to the frame 210, as long as there is tension when external force is applied thereto. For example, although not shown in the drawings, in the case where the detection device 2 according to this embodiment is wound upon a cylindrical object, the second substrate 20 takes on a ring shape, and such a configuration may be employed as long as tension arises when the second substrate 20 is attached to the cylindrical object.

Meanwhile, in the case where the elastic protrusions 22 and the second main substrate portion 21 are formed as an integral entity using an elastic material such as silicone rubber, the configuration may be such that, when using a flat installation, the outer sides are not anchored, as long as a tension arises at least when force is applied thereto.

The second substrate reinforcing portion 23 is formed of, for example, an elastic sheet. Note that in the states shown in FIGS. 9B and 9C, in which an external force has been applied to the second main substrate portion 21, the second substrate reinforcing portion 23 formed of the elastic sheet or the like may also experience elastic deformation under the influence of the external force transmitted through the elastic protrusions 22. Note, however, that FIGS. 9A through 9E illustrate examples in which the second substrate reinforcing portion 23 has not deformed.

Furthermore, although FIGS. 9A through 9E illustrate a structure in which the second main substrate portion 21 and the second substrate reinforcing portion 23 are affixed to the frame 210, it is not necessary to affix both the second main substrate portion 21 and the second substrate reinforcing portion 23 to the frame 210; either one may be affixed, or neither may be affixed, as long as tension is generated when an external force is applied.

The elastic protrusions 22 are connected to the second main substrate portion 21 and the second substrate reinforcing portion 23, and adjacent elastic protrusions 22 pull on each other, and thus affect each other, through the second main substrate portion 21 and the second substrate reinforcing portion 23.

As a result, the elastic protrusions 22 that are connected through the second main substrate portion 21 and the second substrate reinforcing portion 23 affect each other through the tension of the second main substrate portion 21 and the second substrate reinforcing portion 23.

### Third Embodiment

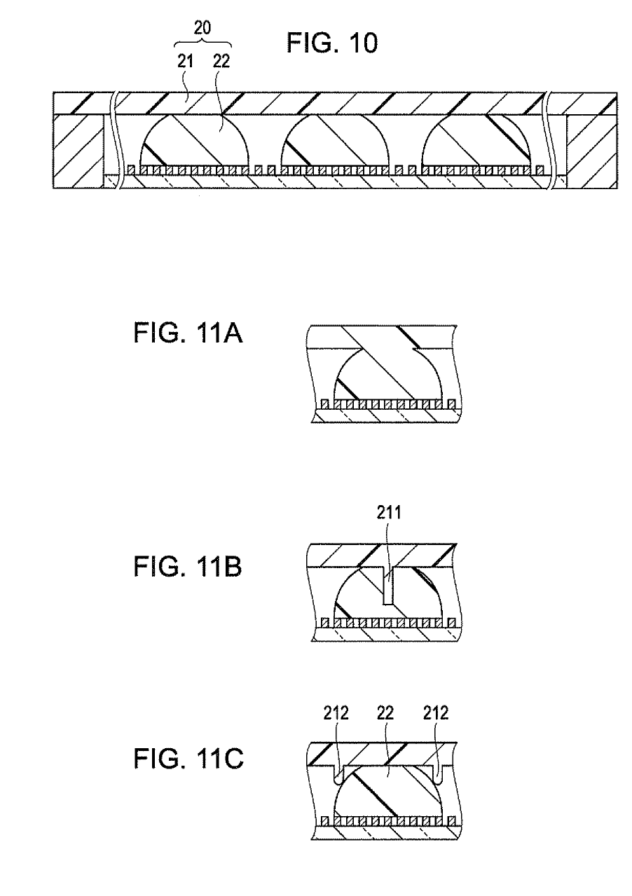

FIG. 10 is a cross-sectional view illustrating force sensors in a detection device 3 according to a third embodiment. In FIG. 10, elements identical to those in the detection device 1 of the first embodiment (see FIGS. 7A through 7E) are given identical reference numerals, and detailed descriptions thereof will be omitted.

The second substrate 20 is configured of the elastic protrusions 22 and the second main substrate portion 21.

The elastic protrusions 22 are formed with their tips facing toward the second main substrate portion 21, and are compressed and deform in the Z direction while making contact with the second main substrate portion 21.

The detection device 3 according to this embodiment differs from the detection device 2 described in the aforementioned second embodiment in that the tips of the elastic protrusions 22 face toward the second main substrate portion 21. However, the detection device 3 according to this embodiment has the same features as the detection device 2 described in the second embodiment with respect to the force sensors.

Note that the method for connecting the elastic protrusions 22 and the second main substrate portion 21 is not limited. For example, FIGS. 11A through 11C illustrate examples of methods for connecting the elastic protrusions 22 and the second main substrate portion 21 of the detection device 3 according to the third embodiment.

FIG. 11A illustrates the elastic protrusion 22 and the second main substrate portion 21 as having an integral structure. Through this, fluctuations in a tension applied to the second main substrate portion 21 can be transmitted to the elastic protrusion 22, which makes it possible to improve the connection strength and the reliability thereof, and makes it possible to eliminate a process for connecting the elastic protrusion 22 and the second main substrate portion 21. This in turn makes it possible to shorten the processing and reduce costs.

FIG. 11B illustrates the elastic protrusion 22 and the second main substrate portion 21 as separate bodies, with part of the second main substrate portion 21 inserted into the elastic protrusion 22. Through this, it is possible to create a structure capable of transmitting fluctuations in a tension applied to the second main substrate portion 21 to the elastic protrusion 22 with a comparatively simple fitting operation, which makes it possible to improve the connection strength and the reliability thereof as well as shorten the processing and reduce costs.

FIG. 11C illustrates the elastic protrusion 22 and the second main substrate portion 21 as separate bodies, with protruding portions 212 of the second main substrate portion 21 disposed so as to make contact with the elastic protrusion 22; in response to an external force in the X and Y directions, the elastic protrusion 22 and the second main substrate portion 21 displace and in doing so affect each other. Through this, the alignment range when fitting the elastic protrusion 22 with the second main substrate portion 21 may be set so that the apex of the elastic protrusion 22 fits between the two protruding portions 212 of the second main substrate portion 21.

Accordingly, it is possible to create a structure capable of transmitting fluctuations in a tension applied to the second main substrate portion 21 to the elastic protrusion 22 with a comparatively simple fitting operation that does not require a high degree of precision during the fitting, which makes it possible to shorten the processing and reduce costs.

### Electronic Apparatus

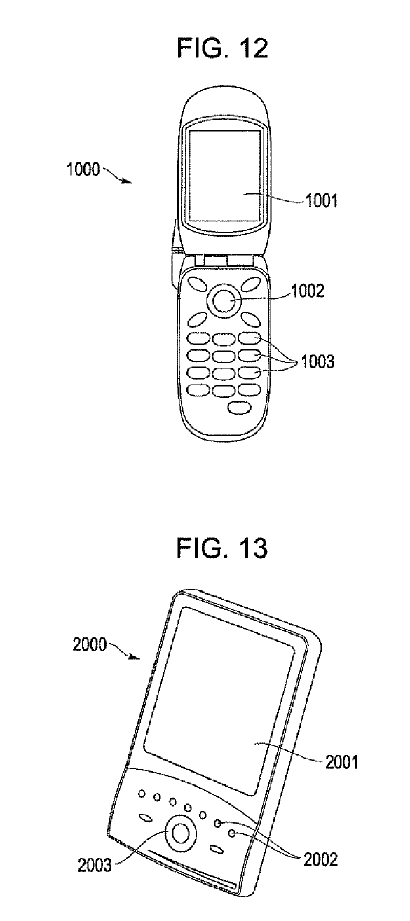

FIG. 12 is a schematic diagram illustrating the overall configuration of a mobile telephone 1000 in which one of the detection devices 1 through 3 according to the aforementioned embodiments has been applied. The mobile telephone 1000 includes a plurality of operation buttons 1003, a control pad 1002, and a liquid-crystal panel 1001 serving as a display unit. Menu buttons (not shown) are displayed in the liquid-crystal panel 1001 by operating the control pad 1002. For example, when the control pad 1002 is pushed firmly in a state in which a cursor (not shown) has been aligned with a menu button, a contact list is displayed, the telephone number of the mobile telephone 1000 is displayed, and so on. Because the detection device according to the aforementioned embodiments is provided in the control pad 1002, at this time, the cursor can be moved with ease simply by changing the direction of the force applied by the finger that carries out the operation, without significantly moving the position of the finger.

FIG. 13 is a schematic diagram illustrating the overall configuration of a personal digital assistant (PDA) 2000 in which one of the detection devices 1 through 3 according to the aforementioned embodiments has been applied. The personal digital assistant 2000 includes a plurality of operation buttons 2002, a control pad 2003, and a liquid-crystal panel 2001 serving as a display unit. A menu displayed in the liquid-crystal panel 2001 can be operated by manipulating the control pad 2003. For example, by firmly pressing the control pad 2003 in a state in which a cursor (not shown) is aligned with a menu (not shown), address records can be displayed, a schedule can be displayed, and so on. Because the detection device according to the aforementioned embodiments is provided in the control pad 2003, at this time, the cursor can be moved, pages can be turned, and so on with ease simply by changing the direction of the force applied by the finger that carries out the operation, without significantly moving the position of the finger.

According to such an electronic apparatus, the aforementioned detection device is provided, and it is thus possible to provide an electronic apparatus capable of detecting the direction of a force with high precision.

It should be noted that the following devices can also be given as examples of electronic apparatuses: personal computers; video camera monitors; car navigation devices; pagers; electronic notepads; calculators; word processors; workstations; videophones; POS terminals; digital still cameras; devices that include touch panels, and so on. The detection device according to the invention can be applied to these electronic apparatuses as well.

### Robot

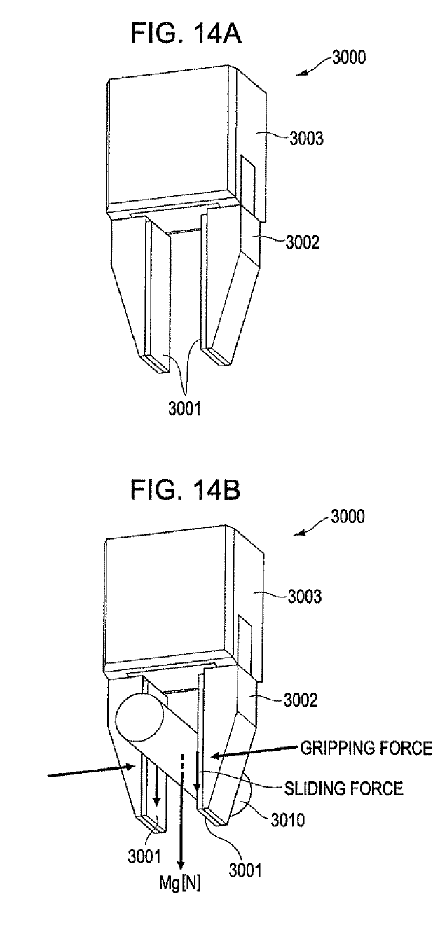

FIGS. 14A and 14B are schematic diagrams illustrating the overall configuration of a robot hand 3000 in which one of the detection devices 1 through 3 according to the aforementioned embodiments has been applied. As shown in FIG. 14A, the robot hand 3000 includes a base portion 3003 and a pair of arm portions 3002, as well as gripping portions 3001 in which the detection device has been applied. Note that the arm portions 3002 open and close when a driving signal has been sent to the arm portions 3002 by a control apparatus such as a remote controller.

A case in which an object 3010 such as a cup is gripped by the robot hand 3000 will be considered, as shown in FIG. 14B. Here, the force acting on the object 3010 is detected as force by the gripping portions 3001. Because the robot hand 3000 includes the stated detection device as the gripping portions 3001, the robot hand 3000 can detect forces in the direction vertical to the surface of the object 3010 (the contact surface) along with the force in which the object 3010 slips under gravity Mg (that is, the sliding force component). For example, the robot hand 3000 can hold the object 3010 with a regulated force in accordance with the qualities of the object 3010, so as not to cause soft objects to deform, drop slippery objects, and so on.

According to such a robot, the aforementioned detection device is provided, and it is thus possible to provide a robot capable of detecting the direction of a force with high precision.

This application claims priority to Japanese Patent Application No. 2011-021445 filed on Feb. 3, 2011. The entire disclosure of Japanese Patent Application No. 2011-021445 is hereby incorporated herein by reference.

What is claimed is:

1. A detection device that detects the direction and magnitude of a force, the apparatus comprising:
a first substrate that includes a plurality of force sensors disposed around a reference point; and
a second substrate on which is formed an elastic protrusion whose center of gravity is positioned in a position that overlaps with the reference point and that elastically deforms due to the force in a state in which the tip of the elastic protrusion makes contact with the first substrate,
wherein the second substrate is an elastic material having a predetermined elasticity, and
the detection device is configured to detect a change in a position of the center of gravity away from the reference point, and to calculate a new position of gravity relative to the reference point.

2. The detection device according to claim 1, further comprising:
an elastic sheet provided between the elastic protrusion and the first substrate,
wherein the tip of the elastic protrusion makes contact with the elastic sheet.

3. A detection device that detects the direction and magnitude of a force, the apparatus comprising:
a first substrate that includes a plurality of force sensors disposed around a reference point;
an elastic protrusion whose center of gravity is positioned in a position that overlaps with the reference point and that elastically deforms due to the force; and
a second substrate provided on the opposite side as the first substrate with the elastic protrusion therebetween,
wherein the elastic protrusion is formed on the first substrate so that the tip of the elastic protrusion makes contact with the second substrate; and
the second substrate is an elastic material having a predetermined elasticity, and
the detection device is configured to detect a change in a position of the center of gravity away from the reference point, and to calculate a new position of gravity relative to the reference point.

4. The detection device according to claim 1, further comprising a support portion that anchors an outer peripheral area of the second substrate in a state in which the support portion applies a tension to the second substrate.

5. The detection device according to claim 1, further comprising a calculation device that calculates differences between force values detected by force sensors combined at random from among force values detected by the plurality of force sensors as the elastic protrusion elastically deforms due to the force, and calculates the direction in which the force is applied and the magnitude of the force based on the differences.

6. The detection device according to claim 1, wherein the plurality of force sensors are disposed symmetrically, with the reference point serving as the point of symmetry.

7. The detection device according to claim 6, wherein the plurality of force sensors are disposed in matrix form in two directions that are orthogonal to each other.

8. The detection device according to claim 7, wherein the plurality of force sensors are disposed in two directions that are orthogonal to each other, with at least four columns and four rows.

9. The detection device according to claim 1, wherein a plurality of the elastic protrusions are formed in the second substrate, and the plurality of elastic protrusions are disposed so as to be distanced from each other.

10. An electronic apparatus comprising the detection device according to claim 1.

11. An electronic apparatus comprising the detection device according to claim 2.

12. An electronic apparatus comprising the detection device according to claim 3.

13. An electronic apparatus comprising the detection device according to claim 4.

14. An electronic apparatus comprising the detection device according to claim 5.

15. A robot comprising the detection device according to claim 1.

16. A robot comprising the detection device according to claim 2.

17. A robot comprising the detection device according to claim 3.

18. A robot comprising the detection device according to claim 4.

19. A robot comprising the detection device according to claim 5.

20. A robot comprising the detection device according to claim 6.
